(19) United States
(12) Patent Application Publication
(10) Pub. No.: US 2012/0319655 A1
(43) Pub. Date: Dec. 20, 2012

(54) METHOD FOR REDUCING ACTIVATION OF LITHIUM SECONDARY BATTERY AND LITHIUM SECONDARY BATTERY HAVING REDUCED ACTIVATION

(76) Inventors: Nathalie Ravet, Montreal (CA); Guoxian Liang, St-Hyacinthe (CA)

(21) Appl. No.: 13/575,817

(22) PCT Filed: Jan. 28, 2011
(86) PCT No.: PCT/CA2011/000103

§ 371 Date: Sep. 4, 2012

Related U.S. Application Data
(60) Provisional application No. 61/298,939, filed on Jan. 28, 2010.

(51) Int. Cl. H02J 7/00; H01M 4/24

(52) U.S. Cl. 320/128; 429/221; 429/224

(57) ABSTRACT

A method for reducing activation of lithium secondary battery including at least a cathode comprising micron-sized particles of a compound having the formula C-AₓM(XO₄)_{y} which have an olivine structure and which carry, on at least a portion of their surface, a deposit of carbon deposited by pyrolysis, the formula AₓM(XO₄)_{y} being such that: A includes Li; M includes Fe(II) or Mn(II) or a mixture thereof; XO₄ includes PO₄; and O<x≦2 et O<y≦2, the coefficients x and y being chosen independently so as to ensure electroneutrality of the AₓM(XO₄)_{y} compound, the method including performing at least one charge and/or discharge cycle of the battery at a temperature above about 30° C. Also, a lithium secondary battery having the above characteristics and which has a substantially constant capacity within the first hundred (100) charge and/or discharge cycles.

### CROSS-REFERENCE TO RELATED APPLICATION

This application claims the benefit of U.S. Provisional Application 61/298,939, filed Jan. 28, 2010, the contents of which are herein incorporated by reference in their entirety.

### BACKGROUND OF THE INVENTION

1. Field of the Invention

The invention relates to a method for reducing activation of lithium secondary batteries containing micron-sized carbon-coated lithiated oxyanion material in the cathode and to such batteries having reduced activation. This method and batteries provide micron-sized cathode material with improved electrochemical performances.

2. Description of the Related Art

In the mid 90's, Goodenough (See U.S. Pat. No. 5,910,382 and U.S. Pat. No. 6,391,493) suggested that polyanionic phosphate structures, namely nasicons and olivines, could raise the redox potential of low cost and environmentally compatible transition metals such as Fe, until then associated to a low voltage of insertion. For example LiFePO₄ was shown to reversibly insert-deinsert lithium ion at a voltage of 3.45 V vs a lithium anode corresponding to a two-phase reaction. Furthermore, covalently bounded oxygen atom in the phosphate polyanion eliminates the cathode instability observed In fully charged layered oxides, making it an inherently safe lithium-ion battery.

As pointed out by Goodenough (U.S. Pat. No. 5,910,382 and U.S. Pat. No. 6,514,640), one drawback associated with the use of covalently bonded polyanions in LiFePO₄ cathode materials is the low electronic conductivity and limited Li⁺ diffusivity in the material. Reducing LiFePO₄ particles to the nanoscale level was pointed out as one solution to these problems as was proposed the partial supplementation of the iron metal or phosphate polyanions by other metal or anions. (See e.g. U.S. Pat. No. 5,910,382 and U.S. Pat. No. 6,514,640).

The suitable choice of particles has allowed the industry to fulfill the needs of various markets, for instance ranging from high-power lithium batteries (submicron-sized particles) to high-energy (micron-sized particles) lithium batteries.

Use of micron-sized particles however, leads to a deleterious phenomenon known as activation, consisting in an increase of cathode material electrochemical capacity during battery cycling. Activation thus remains an ongoing problem for battery manufacturers, in particular when attempting to efficiently balance anode/cathode ratio in cells, and cells in battery packs. Contrarily, submicron-sized particles generally present no or limited activation effect.

There is therefore a need for a lithium secondary batteries containing micron-sized carbon-coated lithiated oxyanion material in the cathode having a reduced activation as well as for a simple method allowing reduction of activation in lithium secondary batteries containing micron-sized carbon-coated lithiated oxyanion material in the cathode.

### SUMMARY OF THE INVENTION

In view to reduce activation of lithium secondary batteries containing micron-sized carbon-deposited lithium metal oxyanion material in the cathode, the present inventors have, after intensive R&D efforts, discovered that performing at least one charge and/or discharge step above ambient temperature, surprisingly and unexpectedly reduced activation of the lithium secondary battery.

In one non-limiting broad aspect, the present invention therefore relates to a method for reducing activation of lithium secondary batteries containing a cathode comprising a lithiated oxyanion compound comprising carbon-coated micron-sized particles.

In another non-limiting broad aspect, the present invention therefore also relates to lithium secondary batteries containing a cathode comprising a titillated oxyanion compound comprising carbon-coated micron-sized particles having a reduced activation.

In one non-limiting embodiment, a lithium secondary battery according to the invention has a substantially constant capacity within the first hundred (100) charge and/or discharge cycles, most preferably during the first twenty (20) charge and/or discharge cycles and most preferably during the first five (5) charge and/or discharge cycles.

In one non-limiting embodiment, in the battery defined above, the therein defined within first hundred (100) charge and/or discharge cycles is within the first and the fifth charge and/or discharge cycle of the lithium secondary battery. In another non-limiting embodiment, it is within the second and the fifth charge and/or discharge cycle of the lithium secondary battery; or within the third and the fifth charge and/or discharge cycle of the lithium secondary battery; or within the first and the 10th; or within the first and the 20th; or within the second and the 10th; or within the second and the 20th; or within the 3rd and the 10th; or within the 3rd and the 20th; or within the fourth and the 10th; or within the fourth and the 20th; or within the 5th and the 10th; or within the 5th and the 20th; or within the 5th and the 100th.

In one non-limiting implementation, the present invention relates to a method for reducing activation of lithium battery comprising at least an anode, a cathode and an electrolyte, the cathode comprising a lithiated oxyanion compound having micron-sized particles, having an olivine structure, wherein the particles carry, on at least a portion of their surface, a deposit of carbon deposited by pyrolysis, wherein the method comprises at least one charge and/or discharge cycle of the battery performed above about 30° C.

In one non-limiting embodiment, the compound has the general formula C-AₓM(XO₄)_{y} wherein A comprises Li; M comprises Fe(II), or Mn(II), or a mixture thereof; XO₄ comprises PO₄, and where 0<x≦2 and 0<y≦2, the coefficients x and y being chosen independently so as to ensure electroneutrality of the AₓM(XO₄)_{y} cathode compound.

These and other aspects and features of the present invention will now become apparent to those of ordinary skill in the art upon review of the following description of specific embodiments of the invention in conjunction with the accompanying drawings.

### BRIEF DESCRIPTION OF THE DRAWINGS

A detailed description of the embodiments of the present invention is provided herein below, by way of example only, with reference to the accompanying drawings, in which:

FIG. 1 illustrates cycling stability of the illustrative C—LiFePO₄ cathode material for two A and B Li/1M LiPF₆ EC:DEC 3:7/C—LiFePO₄ batteries at C/12 charge/discharge rate between 2.2 and 4 Volt and 25° C. temperature. Cathode electrochemical capacity (in mAh/g) is indicated on Y axis and cycle number on X axis. Battery A uses a micron-sized C—LiFePO₄ (Life Power® P1, sold by Phostech Lithium, D₅₀ ca. 2.5 μm), Battery B uses a submicron-sized C—LiFePO₄ (Life Power® P2, sold by Phostech Lithium, D₅₀ ca. 0.6 μm).

FIG. 2 illustrates cycling stability of the illustrative micron-sized C—LiFePO₄ cathode material (Life Power® P1, sold by Phostech Lithium, D₅₀ ca. 2.5 μm) for three A, B and C Li/1M LiPF₆ EC:DEC 3:7/C—LiFePO₄ batteries at C/12 charge/discharge rate between 2.2 and 4 Volt. Cathode electrochemical capacity (in mAh/g) is indicated on Y axis and cycle number on X axis. Battery A has been cycled at 25° C., 1^{st} charge/discharge cycle of battery B has been performed at 45° C. (C/8 charge/discharge rate), 1^{st} charge/discharge cycle of battery C has been performed at 60° C. (C/8 charge/discharge rate), subsequent cycles of both batteries at 25° C. (C/12). Performing 1^{st} cycle at 45° C. reduces notably activation, and at 60° C. activation of micron-sized C—LiFePO₄ is suppressed.

FIG. 3 illustrates cycling stability of the illustrative micron-sized C—LiFePO₄ cathode material (Life Power® P1, sold by Phostech Lithium, D₅₀ ca. 2.5 μm) for three A, B and C Li/1M LiPF₆ EC:DEC 3:7/C—LiFePO₄ batteries at C/12 charge/discharge rate between 2.2 and 4 Volt. Cathode electrochemical capacity (in mAh/g) is indicated on Y axis and cycle number on X axis. Battery A has been cycled at 25° C., 1^{st} charge/discharge cycle of battery B has been performed at 60° C. (C/8 charge/discharge rate), 2^{nd} charge/discharge cycle of battery C has been performed at 60° C. (C/8 charge/discharge rate), subsequent cycles of both batteries at 25° C. (C/12).

### DESCRIPTION OF ILLUSTRATIVE EMBODIMENTS

The inventors have thus developed a method in which activation of lithium secondary batteries, using micron-sized carbon-deposited lithium metal oxyanion cathode material, is reduced by performing at least one charge and/or discharge step above ambient temperature.

In a broad non-limiting implementation, the present invention relates to a method for reducing activation of a secondary lithium battery (also herein referred to a “rechargeable electrochemical cell”) comprising at least an anode, an electrolyte and a cathode, where the cathode comprises micron-sized compound having the general formula C-AₓM(XO₄)_{y}, and wherein at least one charge and/or discharge step of the electrochemical cell is performed above about 30° C.

In one embodiment, the rechargeable electrochemical cell cathode comprises particles of a micron-sized compound corresponding to the general formula C-AₓM(XO₄)_{y} which have an olivine structure and which carry, on at least a portion of their surface, a deposit of carbon deposited by pyrolysis, the general formula AₓM(XO₄)_{y} being such that:
A comprising Li;
M comprising Fe(II) or Mn(II) and mixture thereof;
XO₄ comprising PO₄; and
0<x≦2 et 0<y≦2, the coefficients x and y are chosen independently so as to ensure electroneutrality of the AₓM(XO₄)_{y} cathode compound.

In one embodiment, in the cathode compound C-AₓM(XO₄)_{y}, the deposit of carbon is a uniform, adherent and non-powdery deposit. It represents from about 0.03 to about 15% by weight, preferably from about 0.5 to about 5% by weight, with respect to the total weight of the compound. The deposit of carbon may be obtained by the use of an organic carbon precursor that is pyrolysed onto the cathode compound or its precursors, thus forming a carbon deposit, to improve electrical field at the level of the cathode particles. [See for instance, Ravet (U.S. Pat. No. 6,855,273, U.S. Pat. No. 6,962,666, U.S. Pat. No. 7,344,659, U.S. Pat. No. 7,285,260, U.S. Pat. No. 7,457,018, U.S. Pat. No. 7,601,318, WO 02/27823 and WO 02/27824)].

In a 1^{st} specific embodiment, the compound C-AₓM(XO₄)_{y} is composed of micron-sized particles of a compound corresponding to the general formula AₓM(XO₄)_{y} which have an olivine structure and which carry, on at least a portion of their surface, a deposit of carbon deposited by pyrolysis, the general formula AₓM(XO₄)_{y} being such that;
A represents Li, alone or partially replaced by at most 10% as atoms of Na or K;
M represents Fe(II) or Mn(II) and mixture thereof, alone or partially replaced by at most 30% as atoms of one or more other metals chosen from Ni and Co and/or by at most 30% as atoms of one or more aliovalent or isovalent metals other than Ni or Co, and/or by at most 5% as atoms of Fe(III),
XO₄ represents PO₄, alone or partially replaced by at most 30 mol % of at least one group chosen from SO₄ and SiO₄, and
0<x≦2 et 0<y≦2, the coefficients x and y are chosen independently so as to ensure electroneutrality of the AₓM(XO₄)_{y} cathode compound.

In a 2^{nd} specific embodiment, the compound C-AₓM(XO₄)_{y} is composed of micron-sized particles of a compound corresponding to the general formula AₓM(XO₄)_{y} which have an olivine structure and which carry, on at least a portion of their surface, a deposit of carbon deposited by pyrolysis, the general formula AₓM(XO₄)_{y} being such that:
A represents Li, alone or partially replaced by at most 10% as atoms of Na or K;
M represents Fe(II) or Mn(II) and mixture thereof, alone or partially replaced by at most 30% as atoms of one or more other metals chosen from NI and Co and/or by at most 30% as atoms of one or more aliovalent or isovalent metals chosen from Mg, Mo, Nb, Ti, Al, Ta, Ge, La, Y, Yb, Cu, Sm, Ce, Hf, Cr, Zr, Bi, Zn, Ca, B and W and/or by at most 5% as atoms of Fe(III);
XO₄ represents PO₄, alone or partially replaced by at most 30 mol % of at least one group chosen from SO₄ and SiO₄; and
0<x≦2 et 0<y≦2, the coefficients x and y are chosen independently so as to ensure electroneutrality of the AₓM(XO₄)_{y} cathode compound.

In a 3^{rd} specific non-limiting embodiment, the compound C-AₓM(XO₄)_{y} is composed of particles of a compound corresponding to the general formula LiMPO₄ which have an olivine structure, M comprising at least 90% at. of Fe(II) or Mn(II), or a mixture thereof, and which carry, on at least a portion of their surface, a deposit of carbon deposited by pyrolysis.

In a 4^{th} specific non-limiting embodiment, the compound C-AₓM(XO₄)_{y} is composed of particles of a compound corresponding to the general formula LiFePO₄ which have an olivine structure, and which carry, on at least a portion of their surface, a deposit of carbon deposited by pyrolysis.

By “general formula” one means that the stoichiometry of the material can vary by a few percents from stoichiometry due to substitution or other defects present in the structure, including anti-sites structural defects such as, without any limitation, cation disorder between iron and lithium in LiFePO₄ crystal, see for example Maier et al. [Defect Chemistry of LiFePO₄, Journal of the Electrochemical Society, 155, 4, A339-A344, 2008] et Nazar et al. [Proof of Supervalent Doping in Olivine LiFePO₄, Chemistry of Materials, 2008, 20 (20), 6313-6315].

In a 1^{st} specific embodiment of the method of the present invention, at least the 1^{st} charge step and/or at least the 1^{st} discharge step, is performed above about 30° C., preferably above about 40° C. and most preferably above about 50° C.

In a 2^{nd} specific embodiment of the method of the present invention, at least the 1^{st} charge/discharge or discharge/charge step is performed above about 30° C., preferably above about 40° C. and most preferably above about 50° C.

In the specific case of lithium ion battery using a carbon anode, the first charge/discharge cycle, generally performed at ambient temperature, is critical, as a solid electrolyte interface (SEI) is built on the anode, and the quality of this SEI has an essential impact on the performance of the battery. It could be of interest in this particular case, to apply a method in accordance with the present invention, for instance, after the formation cycle performs to build an optimal SEI layer and subsequently reduce activation.

It is why in a 3^{rd} specific embodiment of the method of the present invention, at least the 2^{nd} or 3^{rd} charge step and/or at least the 2^{nd} or 3^{rd} discharge step, is performed above about 30° C., preferably above about 40° C. and most preferably above about 50° C.

In a 4^{th} specific embodiment of the method of the present invention, at least the 2^{nd} or 3^{rd} charge/discharge or discharge/charge step is performed above about 30° C., preferably above about 40° C. and most preferably above about 50° C.

The person skilled in the art will readily appreciate that a method in accordance with the present invention can be applied at any charge and/or discharge step of the rechargeable electrochemical cell, but preferably during the first hundred (100) cycles, most preferably during the first twenty (20) cycles and most preferably during the first five (5) cycles.

In the context of the present invention, the expression “particles” encompasses both individual particles (primary particles) and agglomerates of individual particles (secondary particles). The size of the primary particles is mostly above about 1 μm preferably between about 1 μm and about 5 μm. The size of the secondary particles is preferably between about 1 μm and about 10 μm. These particle sizes and the presence of the carbon deposit confer, on the C-AₓM(XO₄)_{y} compound, a high specific surface area typically of between about 5 and about 20 m²/g.

In the context of the present invention, the expression “micron-sized compound” also encompasses C-AₓM(XO₄)_{y} with AₓM(XO₄)_{y} primary particles size distribution such as D₅₀ is comprised between about 1 and about 5 μm, and such as C-AₓM(XO₄)_{y} secondary D₅₀ particles size distribution is comprised between about 1 and about 10 μm.

The particle size distribution of the compound according to the invention can be measured using devices commonly used in industry, for example by laser diffraction methods. Mention may be made, as example, of Malvern Instruments particle size analyzers.

The person skilled in the art will readily appreciate that a method in accordance with the present invention can be applied during one or several charge and/or discharge cycle, consecutive or not, by any process allowing to cycle rechargeable electrochemical cell (intentiostatic mode, potentiostatic mode, cyclic voltammetry, . . . ). In addition, the process to cycle the battery could be continuous and/or discontinuous. For example, in intentiostatic mode, charge or discharge current could be applied by pulse.

Temperature of rechargeable electrochemical cell could be controlled by any means, for example either by placing it in an oven or a temperature control chamber, or by heating the battery with a pulse of current and/or an electric voltage signal, preferably of which at least one portion includes an alternating alternative frequency. (See U.S. Pat. No. 5,130,842).

In a specific non-limiting embodiment of the invention, the rechargeable electrochemical cell is a lithium secondary cell constituted by a positive electrode for a lithium secondary cell, a negative electrode and an electrolyte layer.

The positive electrode is comprised of a positive current collector of, for example, an aluminum foil including expanded metal (such as expanded metal foil available from Exmet, USA), optionally with a carbon-based protective coating (such as current collector available from Exopack® Advanced Coating, USA) and a layer of a positive electrode active material comprising C-AₓM(XO₄)_{y} including a binder and generally an electroconductive additive. As a binder contained in the layer of the positive electrode active material, it is possible to use a known resin material routinely used as a binder for the layer of the positive electrode active material for this type of lithium secondary cell, and examples thereof include polyvinylidene fluoride (PVdF), polytetrafluoroethylene, polyvinyl chloride, polyvinylpyrrolidone, styrene-butadiene rubber (SBR), polymethylmethacrylate (PMMA), polyethylene oxide (PEO) and mixtures thereof. Among these, polyvinylidene fluoride and derivatives are preferably used for lithium ion type battery, PEO and derivatives are preferably used for lithium metal polymer battery. As an electronic conductive additive contained in the layer of the positive electrode active material, it is possible to use a known conductive agent routinely used for this type of secondary lithium cell in, without any limitation, spherical (granular) form, flaky form, a fibrous form and the like, and examples thereof include carbon black, graphite, carbon fiber, nanotube, graphene, vapor growth conductive fiber (VGCF) and mixtures thereof.

The negative electrode is preferably one capable of occluding and releasing metallic lithium or lithium ion, and the material thereof is not particularly limited and may be a known material, such as an alloy and hard carbon. Specifically, the negative electrode may contain a collector having coated thereon a material obtained by mixing a negative electrode active substance and a binder. The negative electrode active substance may be a known active substance without particular limitation. Examples thereof include a carbon material, such as natural graphite, artificial graphite, non-graphitizable carbon and graphitizable carbon, a metallic material, such as metallic lithium, a lithium alloy and a tin compound, a lithium-transition metal nitride, a crystalline metallic oxide an amorphous metallic oxide, a titanium oxide, such as TiO₂ or carbon-coated TiO₂, a lithium titanium oxide such as Li₄Ti₅O₁₂ or carbon-coated Li₄Ti₅O₁₂, and an electroconductive polymer. The binder may be a known organic or inorganic binder without particular limitation, and examples thereof include those shown for the binder that can be used in the positive electrode, such as polyvinylidene fluoride (PVdF). Examples of the collector of the negative electrode include copper and nickel in the form of a mesh, a punching metal, a foamed metal, a foil processed into a plate, or the like.

The electrolyte layer is held with the positive electrode layer and the negative electrode layer and contains an electrolytic solution, a polymer containing an electrolytic salt, a polymer gel electrolyte, or a polymer electrolyte plasticized or not. In the case where an electrolytic solution or a polymer gel electrolyte is used, a separator is preferably used in combination. The separator electrically insulates the positive electrode and the negative electrode and retains an electrolytic solution or the like.

The electrolytic solution may be any electrolytic solution that is ordinarily used in a lithium secondary cell, and includes ordinary examples of an organic electrolytic solution, polymer electrolyte, or an ionic liquid and mixtures thereof. Examples of the electrolytic salt include LiPF₆, LiBF₄, LiClO₄, LiAsF₆, LiCl, LiBr, LiCF₃SO₃, LiN(CF₃SO₂)₂, LiC(CF₃SO₂)₃, LiN(FSO₂)₂, LiC(FSO₂)₃, lithium bis(oxalato)borate, lithium difluoro(oxaiato)borate, lithium tetrafluoro(oxalato)phosphate, Li₂B₁₂FₓH₁₂₋ₓ (10≦x≦12), LiI, LiAlCl₄, NaClO₄, NaBF₄ and NaI, and particularly an inorganic lithium salt, such as LiPF₆, LiBF₄, LiClO₄, and an organic lithium salt represented by LiN(SO₂CₓF₂ₓ₊₁)(SO₂C_{y}F_{2y+1}), wherein x and y each represents independently an integer of 0 or from 1 to 4, provided that x+y is from 2 to 8. Specific examples of the organic lithium salt include LiN(SO₂F)₂, LiN(SO₂CF₃)(SO₂C₂F₆), LiN(SO₂CF₃)(SO₂C₃F₇), LiN(SO₂CF₃)(SO₂C₄F₉), LiN(SO₂C₂F₅)₂, LiN(SO₂C₂F₅)(SO₂C₃F₇) and LiN(SO₂C₂F₅)(SO₂C₄F₉). Among these, LiPF₆, LiBF₄, LiN(CF₃SO₂)₂, LiN(SO₂F)₂ and LiN(SO₂C₂F₅)₂ are preferably used as the electrolyte owing to the excellent electric characteristics thereof. The electrolytic salt may be used solely or as a combination of two or more kinds of them.

The organic solvent for dissolving the electrolytic salt may be any organic solvent that is ordinarily used in a non-aqueous electrolytic solution of a lithium secondary cell without particular limitation, and examples thereof include a carbonate compound, a lactone compound, an ether compound a sulfolane compound, a dioxolane compound, a ketone compound, a nitrile compound and a halogenated hydrocarbon compound. Specific examples thereof include a carbonate compound, such as dimethyl carbonate, methylethyl carbonate, diethyl carbonate, ethylene carbonate, fluoroethylene carbonate, propylene carbonate, ethylene glycol dimethyl carbonate, propylene glycol dimethyl carbonate, ethylene glycol diethyl carbonate and vinylene carbonate, a lactone compound, such as δ-butyrolactone, an ether compound, such as dimethoxyethane, tetrahydrofuran, 2-methyltetrahydrofuran, tetrahydropyran and 1,4-dioxane, a sulfolane compound, such as sulfolane and 3-methylsulfolane, a dioxolane compound, such as 1,3-dioxolane, a ketone compound, such as 4-methyl-2-pentanone, a nitrile compound, such as acetonitrile, propionitrile, valeronitrile and benzonitrile, a halogenated hydrocarbon compound, such as 1,2-dichloroethane, and an ionic liquid, such as methyl formate, dimethylformamide, diethylformamide, dimethylsulfoxide, an imidazolium salt and a quaternary ammonium salt. The organic solvent may be a mixture of these solvents. Among the organic solvents, at least one non-aqueous solvent selected from the group consisting of carbonate compounds is preferably contained since it is excellent in solubility of the electrolyte, dielectric constant and viscosity. Examples of the polymer compound used in the polymer electrolyte or the polymer gel electrolyte include a polymer, a copolymer and a crosslinked product thereof of ether, ester, siloxane, acrylonitrile, vinylidene fluoride, hexafluoropropylene, acrylate, methacrylate, styrene, vinyl acetate, vinyl chloride, oxetane or the like, and the polymer may be used solely or as a combination of two or more kinds of them. The polymer structure is not particularly limited, and a polymer having an ether structure, such as polyethylene oxide, is particularly preferred.

In the lithium secondary cell, an electrolytic solution is housed in a cell container for a liquid system cell, a precursor liquid having a polymer dissolved in an electrolytic solution is housed therein for a gel system, or a polymer before crosslinking having an electrolytic salt dissolved therein is housed therein for a solid electrolyte system cell.

The separator may be any separator that is ordinarily used in a lithium secondary cell without particular limitation, and examples thereof include a porous resin formed of polyethylene, polypropylene, polyolefin, polytetrafluoroethylene or the like, ceramics and nonwoven fabric. The separator may be a dry or plasticized polymer having an ether structure, such as polyethylene oxide for lithium metal polymer batteries.

It could be advantageous to operate a method in accordance with the present invention on a mixture of different grades of C-AₓM(XO₄)_{y}, such as material with different particle size distribution, for example, without any limitation, mixture comprising at least one submicron-sized C-AₓM(XO₄)_{y} and at least one micron-sized C-AₓM(XO₄)_{y}. Such mixture allows cathode optimization in terms of energy and power density.

It could also be advantageous to a method in accordance with the present invention on a mixture of at least one C-AₓM(XO₄)_{y} and at least one cathode material with a different chemistry, such as, without any limitation LiCoO₂, LiMn₂O₄, lithium nickel manganese cobalt oxide, lithium nickel manganese oxide, lithium nickel cobalt aluminum oxide.

In accordance with a specific implementation, the carbon-deposited alkali metal oxyanion material may comprise at its surface or in the bulk, additives, such as, without any limitation, carbon particles, carbon fibers and nanofibers, carbon nanotubes, graphene, metallic oxides, and mixture thereof.

The foregoing is considered as illustrative only of the principles of the invention. Further, since numerous modifications and changes will readily occur to those skilled in the art, it is not desired to limit the invention to the exact examples and embodiments shown and described, and accordingly, all suitable modifications and equivalents may be resorted to, falling within the scope of the invention.

### EXAMPLES

### Preparative Example 1

### Preparation of Liquid Electrolyte Batteries

Liquid electrolyte batteries were prepared according to the following procedure:

A cathode material, PVdF-HFP copolymer (supplied by Atochem), and EBN-1010 graphite powder (supplied by Superior Graphite) were carefully mixed in N-methyl-pyrrolidone for one hour using zirconia beads in a Turbula® mixer in order to obtain a dispersion composed of the cathode/PVdF-HFP/graphite 80/10/10 by weight mixture. The mixture obtained was subsequently deposited, using a Gardner® device, on a sheet of aluminum carrying a carbon-treated coating (supplied by Exopack® Advanced Coating) and the film deposited was dried under vacuum at 80° C. for 24 hours and then stored in a glovebox.

A battery of the “button” type was assembled and sealed in a glovebox, use being made of the carbon-treated sheet of aluminum carrying the coating comprising the material C—LiFePO₄, as cathode (C—LiFePO₄ cathode loading of 4.5 mg/cm²), a film of lithium, as anode, and a separator having a thickness of 25 μm (supplied by Celgard) impregnated with a 1M solution of LiPF₆ in an EC/DEC 3/7 mixture.

### Comparative Example 1

### Cycling of Submicron and Micron-Sized C—LiFePO₄

Two A and B Li/1M LiPF₆ EC:DEC 3:7/C—LiFePO₄ batteries were assembled as disclosed in preparative example 1, battery A uses a micron-sized C—LiFePO₄ (Life Power® P1, sold by Phostech Lithium, D₅₀ ca. 2.5 μm), whereas battery B uses a submicron-sized C—LiFePO₄ (Life Power® P2, sold by Phostech Lithium, D₅₀ ca. 0.6 μm).

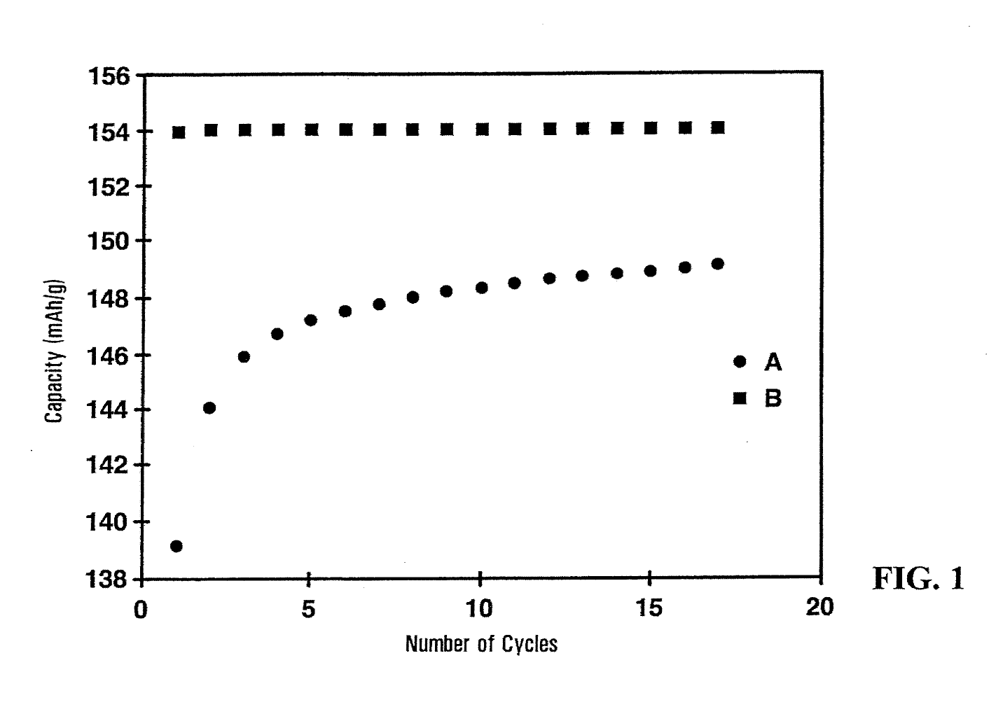

The batteries were tested with intensiostatic cycling at 25° C. and a rate of C/12 (assuming a capacity equal to 80% of C—LiFePO₄ theorical capacity), first in oxydation from the rest potential up to 4 V and then in reduction between 4 V and 2.2 V, following charge/discharge cycles in a range of 2.2 and 4 V. Evolution of cathode material capacity with cycling is provided in FIG. 1 for battery A (micron-sized C—LiFePO₄) and B (submicron-sized C—LiFePO₄).

It could be observed that micron-sized C—LiFePO₄ presents an important activation effect, whereby the capacity increases from ca, 139 to ca. 149 mAh/g after 15 cycles.

### Example 1

Three A, B and C Li/1M LiPF₆ EC:DEC 3:7/C—LiFePO₄ batteries were assembled as disclosed in preparative example 1, where each of battery A, B and C uses similar micron-sized C—LiFePO₄ (Life Power® P1, sold by Phostech Lithium, D₅₀ ca. 2.5 μm) cathode compound.

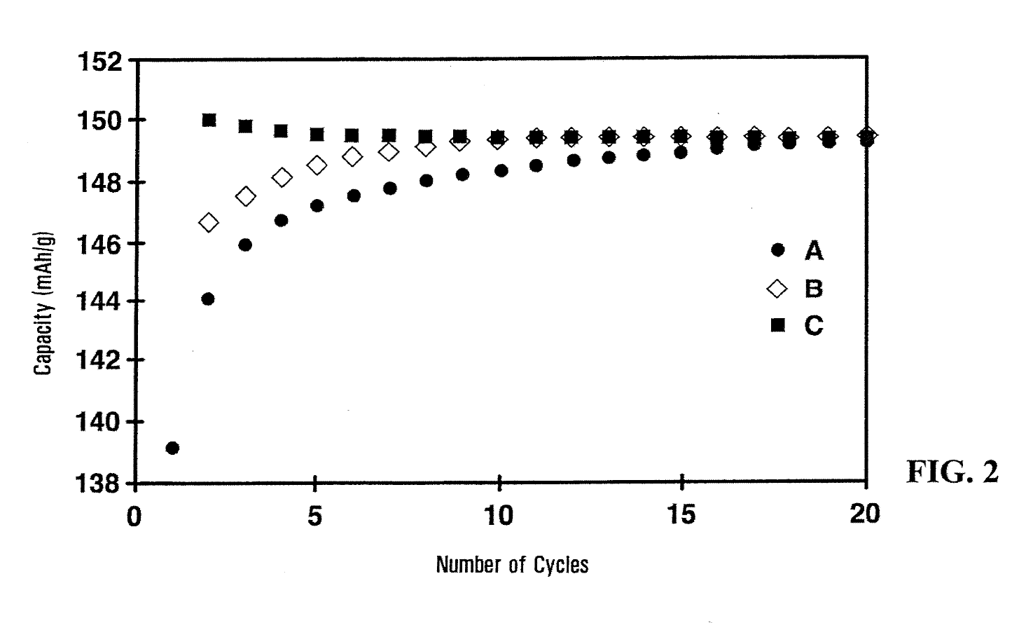

The batteries were tested with intensiostatic cycling, first in oxydation from the rest potential up to 4 V and then in reduction between 4 V and 2.2 V, at a temperature of 25° C. and a rate of C/12 for battery A, at a temperature of 45° C. and a rate of C/8 for battery B, and at a temperature of 60° C. and a rate of C/8 for battery C, rate determined assuming a capacity equal to 80% of C—LiFePO₄ theorical capacity. Subsequent cycles for battery A, B and C were performed at 25° C. and a rate of C/12 in a range of 2.2 and 4V. Evolution of cathode compound capacity with cycling are provided in FIG. 2 for battery A, B and C.

Surprisingly and unexpectedly, it could be observed that micron-sized C—LiFePO₄ activation is reduced by performing first charge/discharge cycle at 45° C. and is substantially suppressed by performing first charge/discharge cycle at 60° C.

Similar experiments have been performed with C—LiFe_{0.95}M_{0.05}PO₄ (M=Co, Nb, Mg and Mn) cathode compounds presenting activation. Activation was also substantially suppressed by performing first charge/discharge cycle at 60° C.

### Example 2

Three A, B and C Li/1M LiPF₆ EC:DEC 3:7/C—LiFePO₄ batteries were assembled as disclosed in preparative example 1, with cathode from same coating used in example 1.

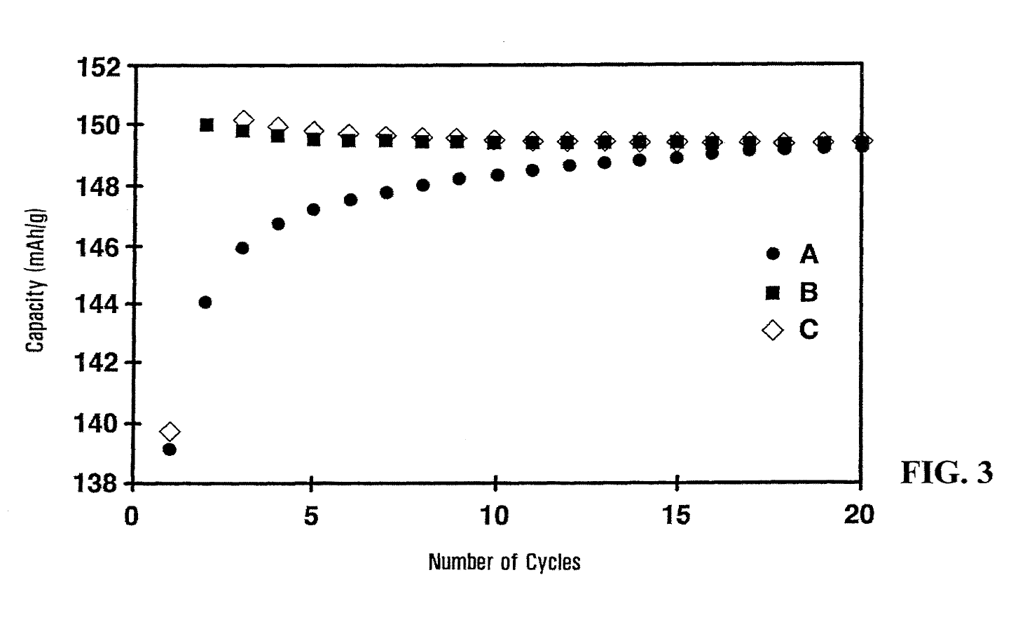

The batteries were tested with intensiostatic cycling, first in oxydation from the rest potential up to 4 V and then in reduction between 4 V and 2.2 V. Battery A was cycled at 25° C., 1^{st} charge/discharge cycle of battery B was performed at 60° C. (C/8 charge/discharge rate), 2^{nd} charge/discharge cycle of battery C was performed at 60° C. (C/8 charge/discharge rate), with subsequent cycles of both batteries at 25° C. (C/12). Evolution of cathode materials capacity with cycling are provided in FIG. 3 for battery A, B and C.

Performing first or second charge/discharge cycle at 60° C. provided similar substantial suppression of activation.

### Example 3

Four A, A1, B and B1 lithium ion batteries (LFP26650EV, K2 Energy Solutions, USA) using as cathode material a specific C—LiFePO₄ batch (Life Power® P1) with activation effect were obtained.

The as received batteries A and B were tested with intensiostatic cycling, first in oxydation from the rest potential up to 3.8 V and then in reduction between 3.8 V and 2V. Battery A was cycled at 25° C., 1^{st} charge/discharge and 2^{nd} charge cycle of battery B was performed at 60° C. (C/8 charge/discharge rate), with subsequent cycles at 25° C. (C/12).

The as received Batteries A1 and B1 were tested with intensiostatic cycling, first in reduction from the rest potential up to 2 V and then in oxydation between 2 V and 3.8 V. Battery A1 was cycled at 25° C., 1^{st} discharge/charge and 2^{nd} discharge/charge cycle of battery B1 was performed at 60° C. (C/8 charge/discharge rate), with subsequent cycles at 25° C. (C/12).

Batteries A and A1 presented activation during cycling, whereas for batteries B and B1 activation was suppressed by applying a method in accordance with the present invention.

Although the present invention has been described in considerable detail with reference to certain embodiments thereof, variations and refinements are possible without departing from the spirit of the invention. All of the compositions and/or methods disclosed and claimed herein can be made and executed without undue experimentation in light of the present disclosure. While the compositions and methods of this invention have been described in terms of preferred embodiments, it will be apparent to those of skill in the art that variations can be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

All references cited throughout the specification are hereby incorporated by reference in their entirety.

1. A method for reducing activation of lithium secondary battery comprising at least an anode, a cathode and an electrolyte, the cathode comprising micron-sized particles of a compound having the general formula C-AₓM(XO₄)_{y} which have an olivine structure and which carry, on at least a portion of their surface, a deposit of carbon deposited by pyrolysis, the general formula AₓM(XO₄)_{y} being such that:
A comprises Li;
comprises Fe(II) or Mn(II) or a mixture thereof;
XO₄ comprises PO₄; and
0<x<2 et 0<y<2, the coefficients x and y being chosen independently so as to ensure electroneutrality of the AₓM(XO₄)_{y} compound, said method comprising performing at least one charge and/or discharge cycle of the battery at a temperature above about 30° C.

2. A method according to claim 1, wherein the deposit of carbon is a uniform, adherent and non-powdery deposit and represents from about 0.03 to about 15% by weight, with respect to the total weight of the compound.

3. A method according to claim 1, wherein:
A represents Li, alone or partially replaced by at most 10% as atoms of Na or K;
M represents Fe(II) or Mn(II) or a mixture thereof, alone or partially replaced by at most 30% as atoms of one or more other metals chosen from Ni and Co and/or by at most 30% as atoms of one or more aliovalent
or isovalent metals other than Ni or Co, and/or by at most 5% as atoms of Fe(III); and
XO₄ represents PO₄, alone or partially replaced by at most 30 mol % of at least one group chosen from SO₄ and SiO₄.

4. A method according to claim 1, wherein:
A represents Li, alone or partially replaced by at most 10% as atoms of Na or K;
M represents Fe(II) or Mn(II) or a mixture thereof, alone or partially replaced by at most 30% as atoms of one or more other metals chosen from Ni and Co and/or by at most 30% as atoms of one or more aliovalent or isovalent metals chosen from Mg, Mo, Nb, Ti, Al, Ta, Ge, La, Y, Yb, Sm, Ce, Hf, Cr, Zr, Bi, Zn, Ca, B and W and/or by at most 5% as atoms of Fe(III);
XO₄ represents PO₄, alone or partially replaced by at most 30 mol % of at least one group chosen from SO and SiO₄.

5. A method according to claim 1, wherein the AₓM(XO₄)_{y} has the general formula LiMPO₄, wherein M is a metal comprising at least 90% at. of Fe(II) or Mn(II).

6. A method according to claim 1, wherein the AₓM(XO₄)_{y} has the general formula LiFePO₄.

7. A method according to claim 1, wherein in the compound, M is at least 70% as atoms of Mn or Fe or a mixture thereof.

8. A method according to claim 1, wherein said at least one charge and/or discharge cycle of the battery is the first charge and/or discharge cycle of the lithium secondary battery.

9. A method according to claim 1, wherein said at least one charge and/or discharge cycle of the battery is the second or third charge and/or discharge cycle of the lithium secondary battery.

10. A method according to claim 1, wherein said at least one charge and/or discharge cycle of the battery is within the first one hundred (100) cycles of the lithium secondary battery.

11. A method according to claim 1, wherein the compound is composed of primary particles having an about 1 μm≦D₅₀≦about 5 pm.

12. A method according to claim 1, wherein the compound is composed of secondary particles having an about 1 μm≦D₅₀≦about 10 pm.

13. A method according to claim 1, wherein said at least one charge and/or discharge cycle is perform in intentiostatic mode, potentiostatic mode, cyclic voltammetry, or any combinations thereof.

14. A method according to claim 1, wherein said temperature is obtained by at least partly heating the lithium secondary battery by applying a pulse of current and/or an electric voltage signal.

15. A method according to claim 1, wherein said temperature is about 60° C.

16. A lithium secondary battery comprising at least an anode, a cathode and an electrolyte, the cathode comprising micron-sized particles of a compound having the general formula C-AₓM(XO₄)_{y} which have an olivine structure and which carry, on at least a portion of their surface, a deposit of carbon deposited by pyrolysis, the general formula AₓM(XO₄)_{y} being such that:
A comprises Li;
M comprises Fe(II) or Mn(II) or a mixture thereof;
XO₄ comprises PO₄; and
0<x≦2 et 0<y≦2, the coefficients x and y being chosen independently so as to ensure electroneutrality of the AₓM(XO₄)_{y} compound,
wherein said battery has a substantially constant capacity within the first hundred (100) charge and/or discharge cycles.

17. A lithium secondary battery according to claim 16, wherein the deposit of carbon is a uniform, adherent and non-powdery deposit and represents from about 0.03 to about 15% by weight, with respect to the total weight of the compound.

18. A lithium secondary battery according to claim 17, wherein:
A represents Li, alone or partially replaced by at most 10% as atoms of Na or K;
M represents Fe(II) or Mn(II) or a mixture thereof, alone or partially replaced by at most 30% as atoms of one or more other metals chosen from Ni and Co and/or by at most 30% as atoms of one or more aliovalent or isovalent metals other than Ni or Co, and/or by at most 5% as atoms of Fe(III); and
XO₄ represents PO₄, alone or partially replaced by at most 30 mol % of at least one group chosen from SO₄ and SiO₄.

19. A lithium secondary battery according to claim 17, wherein:
A represents Li, alone or partially replaced by at most 0% as atoms of Na or K;
M represents Fe(II) or Mn(II) or a mixture thereof, alone or partially replaced by at most 30% as atoms of one or more other metals chosen from Ni and Co and/or by at most 30% as atoms of one or more aliovalent or isovalent metals chosen from Mg, Mo, Nb, Ti, Al, Ta, Ge, La, Y, Yb, Sm, Ce, Hf, Cr, Zr, Bi, Zn, Ca, B and W and/or by at most 5% as atoms of Fe(III);
XO₄ represents PO₄, alone or partially replaced by at most 30 mol % of at least one group chosen from SO₄ and SiO₄.

20. A lithium secondary battery according to claim 17, wherein the AₓM(XO₄)_{y} has the general formula LiMPO₄, wherein M is a metal comprising at least 90% at. of Fe(II) or Mn(II).

21. A lithium secondary battery according to claim 17, wherein the AₓM(XO₄)_{y} has the general formula LiFePO₄.

22. A lithium secondary battery according to claim 17, wherein in the compound, M is at least 70% as atoms of Mn or Fe or a mixture thereof.

23. A lithium secondary battery according to claim 17, wherein said within first hundred (100) charge and/or discharge cycles is within the first and the fifth charge and/or discharge cycle of the lithium secondary battery.

24. A lithium secondary battery according to claim 17, wherein said within first hundred (100) charge and/or discharge cycles is within the second and the fifth charge and/or discharge cycle of the lithium secondary battery.

25. A lithium secondary battery according to claim 17, wherein said within first hundred (100) charge and/or discharge cycles is within the third and the fifth charge and/or discharge cycle of the lithium secondary battery.

26. A lithium secondary battery according to claim 17, wherein the compound is composed of primary particles having an about 1 μm≦D₅₀≦about 5 μm.

27. A lithium secondary battery according to claim 17, wherein the compound is composed of secondary particles having an about 1 μm≦D₅₀≦about 10 μm.

28. A lithium secondary battery according to claim 21, wherein said constant capacity is at least 80% of the LiFePO₄ theoretical capacity.
